(19) United States
(12) Patent Application Publication
(10) Pub. No.: US 2025/0232221 A1
(43) Pub. Date: Jul. 17, 2025

(54) Method and Device for Identifying Variables from a Plurality of Variables Having a Dependence on a Predetermined Variable from the Plurality of Variables

(71) Applicant: Robert Bosch GmbH, Stuttgart (DE)

(72) Inventor: Mark Herrmann, Radebeul (DE)

(21) Appl. No.: 19/018,062

(22) Filed: Jan. 13, 2025

(30) Foreign Application Priority Data
Jan. 17, 2024 (DE) 10 2024 200 425.1

(51) Int. Cl. G06N 20/00

(52) U.S. Cl. CPC G06N 20/00

(57) ABSTRACT

A method is for identifying at least one variable from a plurality of variables having a dependence on a predetermined variable from the plurality of variables. The method includes providing a data set comprising data points for a plurality of variables for a plurality of products respectively and selecting the predetermined variable from the plurality of variables. The data set is pre-processed by adding at least one random variable. A machine learning system is trained on the pre-processed data set and a determination of the dependencies of the variables on the predetermined variable based on the trained machine learning system. The dependencies learned by the trained machine learning system are made understandable and thus usable for root cause analysis using methods of “interpretable machine learning”, such as the extraction of variable importance or effects.

This application claims priority under 35 U.S.C. § 119 to patent application no. DE 10 2024 200 425.1, filed on Jan. 17, 2024 in Germany, the disclosure of which is incorporated herein by reference in its entirety.

The disclosure relates to a method for identifying variables from a plurality of variables having a dependence on a predetermined variable from the plurality of variables, preferably by means of a random forest, as well as a device, a computer program and a machine-readable storage medium.

### BACKGROUND

Determining causes of a failure in a system, in particular in a production system, is known as the root cause analysis.

The publication of the authors Solé, M., Muntés-Mulero, V., Rana, A. I., & Estrada, G. (2017). Survey on models and techniques for root-cause analysis, provides an overview of techniques for data-based modeling of system behavior and root cause analysis based on modeling.

Although the use of machine learning (ML)-based models, such as a random forest, makes it possible to model complex dependencies, these models have another challenge: In contrast to classical, statistical (parametrized) models, whose parameters often allow direct conclusions to be drawn about the “importance” and the “effect” of individual variables for the model or on the prediction values of the model, it is usually not possible to directly identify these “importance” and “effect” metrics, especially in complex ML-based models. As long as the purpose of a model is only to predict a dependent variable as accurately as possible, this is not a problem. However, in the case of root cause analysis, additional metrics for “importance” and “effect” are needed to interpret the model results These interpretation methods are often grouped under the term “interpretable machine learning” or “IML” (Molnar et. al.: “General Pitfalls of Model-Agnostic Interpretation Methods for Machine Learning Models”|SpringerLink. The additional computational effort associated with these methods can be significant, which is why their use in practice for interactive root cause analysis, where the expertise of process experts can also be incorporated, is challenging.

A method for identifying at least one variable with high “Importance” from a plurality of variables, which has a correlation with a predetermined variable from the plurality of variables, is known from the non-published DE 10 2022 208 394. The method begins with providing a data set comprising data points for a plurality of variables for a plurality of products respectively and a selection of the predetermined variable from the plurality of variables. The data set is then pre-processed. Then, there follows a training of a machine learning system on the pre-processed data set and a determination of the dependencies of the variables on the predetermined variable based on the trained machine learning system.

The importance of individual variables in a model can be extracted using various known methods (e.g. using a permutation importance or impurity importance). These methods deliver different results from the same model and have different advantages and disadvantages.

For example, an impurity importance is a score that is obtained almost “for free” when using decision tree models, but it tends to systematically underestimate the importance of categorical variables with a small number of categories.

An alternative that is not limited to decision trees is the so-called permutation importance, which, however, in certain cases produces unreliable results because it determines model errors in extrapolated value ranges where these are naturally high.

However, since the two importance metrics mentioned above can provide very different values in individual cases, it has proven to be impractical to return both values separately to the user.

In recent years, a plurality of methods have been developed for extracting these effects, some of which are model-agnostic, i.e. they can be applied to any type of machine learning model (comparable to permutation importance) and are not (like impurity importance) limited to certain models.

A distinction is made between methods that extract “effects” for individual predictions (“local effects”) and those that do so for an entire data set (“global effects”).

However, what all of the above methods have in common is that it is not obvious to the user below which importance or effects value a variable does not make a meaningful contribution to the model or its predictive value. Variables that do not make a significant contribution to the model can be removed from the model to obtain a less complex and thus more robust model. Variables that do not have a sufficiently strong lever (“effect”) to influence the value of the dependent variable in the desired way and to the desired extent may not be useful for solving the problem. It is therefore important to provide a threshold value for “importance” or “effects” metrics, below which variables only contribute to the model as noise or do not provide sufficient leverage. Even if there are feature selection algorithms that automate the reduction of the variables used based on importance metrics, such as Boruta, such methods are sometimes very computationally intensive, often require a large number of observations to work effectively, and do not allow subject matter experts to intervene based on their expertise.

The same applies to the removal of correlated variables: here, too, it is not obvious to the user below which threshold value a correlation measure>0 may be due exclusively to noise.

The non-published DE 10 2023 202 838.7 describes a method for determining threshold values for “importance” but also for the correlation measure, which is based on enriching the data set with a categorical and a numerical random variable. This procedure can also be used to determine threshold values for “effects” and makes it possible to limit the calculation-intensive determination of “effect” metrics to only important variables.

One task of this disclosure is to improve and simplify root cause analysis so that it can be used preferably in real time and interactively.

### SUMMARY

The advantage of the disclosure is that it provides an importance metric that generates a single and reliably and easily sortable key figure that allows variables to be sorted by importance. This also makes it possible to further automate a root cause analysis and, for example, to iteratively train further models based only on the top N variables or to perform additional, computationally intensive calculations for the extraction of the “effects” only for the top N variables. In other words, the importance metric makes it possible to sort the variables according to their importance in the model using a single key figure and, if necessary, to automate further steps (such as removing unimportant variables from the model or calculating additional metrics only for important variables).

Another advantage of the disclosure is that three additional “effect” metrics are introduced. An effect size metric that allows the size of the leverage of individual variables to be assessed. An effect metric that allows the shape and course of the effect of an individual variable on the dependent variable to be visualized. A third metric that allows interactions between two variables to be quantified or visualized.

In a first aspect, the disclosure relates to a computer-implemented method for identifying at least one variable from a plurality of variables having a dependence on a predetermined variable from the plurality of variables. The variables each characterize measurements after production steps of a product or the production steps or machine settings of machines performing one of the production steps. An abstract (causal) relationship can be understood by the dependence, by which the identified variable affects the predetermined variable, i.e. the dependence can be considered a correlation.

The method begins with providing a data set comprising data points for a plurality of variables for a plurality of products respectively. The data set is preferably a matrix or table. The columns of the matrix are each assigned to one of the variables, while the rows each contain a data point that was recorded for the respective product for the respective variable. A line can also be understood as a measurement series. The data set can be sparsely occupied. It is therefore conceivable that the data set, in particular the matrix, has empty entries along the dimension for the variables as well as along the dimension for the products. That is to say, there are variables whose measurements or the like were not measured for the respective product, but other measurements for this product have already been carried out.

The products can be semiconductor products such as wafers or frames (a frame can be understood as an exposure field on a wafer, therefore a repetitive arrangement of individual chips on the wafer) or chips or other semiconductor components, which were particularly manufactured with the same manufacturing machines or in the same factory. The plurality of the products can be identical products or can differ in certain configurations with respect to each other. It is also conceivable that the plurality of the products are different products, which in particular were manufactured with the same production machines or at the same factory.

This is followed by selecting or defining the predetermined variable from the plurality of variables. The predetermined variable should be the variable for which, for example, an intolerable deviation of its range of values or values outside a defined range of values has been observed. The predetermined variable can be selected because of its abnormal behavior for a product or a plurality of products. Preferably, a root cause analysis is to be performed for the predetermined variable. It is conceivable that the predetermined variable is provided by a user.

With regard to a pre-processing of the data set, it should be noted that in particular in the case that the data set has a very high number of variables, manual pre-selection of those variables can be made for which it is assumed that they have an influence on the predetermined variable.

This may be followed by pre-processing of the data set. The pre-processing step comprises at least extending the provided data set by a numerical and/or categorical random variable characterizing a probability distribution, wherein data points for the random variable are randomly drawn according to the probability distribution and added to the provided data set.

The step of pre-processing the data set can additionally comprise the following further steps: During pre-processing, those variables and/or products are additionally deleted, in particular on a row-by-row and/or column-by-column basis, which show a sparsity of the data points greater than a predetermined threshold value. The sparsity can be understood to mean that data points do not exist for each product for a given variable, or data points do not exist for each variable for a given product. The sparsity can be stated as a percentage, for example, how many data points should ideally be given and how many data points are missing from this. For example, the threshold value is a percentage. For example, the threshold value for the data points of the products is ≤10% and for the variables<60%. The advantage of the first step is that it effectively achieves a reasonable sparsity of the data set. It is conceivable that the first step of pre-processing differentiates between missing data points that were not recorded but could have been recorded in practice and missing data points because the product was not manufactured for this purpose. For the missing data points that were not recorded but could have been captured in practice, they remain empty and will then be removed during sparse filtering. For the missing data points that were not recorded and for which the product was not manufactured for this purpose, “not processed” can be stored as a placeholder data point during the first step. This is a simple way to take into account the significance of non-existing data and advantageously reduce the sparsity.

The step of pre-processing the data set can additionally comprise as a further step: During pre-processing, missing data points for the variables are also imputed. During imputation, missing data points are replaced in a first step with a data point from the respective variable that occurs most frequently (categorical variables) or occurs on average (e.g., median) across the plurality of the products (numerical variables). Based on this imputed data set, training a first machine learning system can be followed to predict the originally missing data points by the machine learning system depending on the given data points. This step can be repeated several times until an abort criterion is reached, in order to iteratively improve the quality of the imputed data. An example of such a multiple imputation algorithm is MICE (doi:10.18637/jss.v045.i03>). The model form used for this first learning system is adaptable in principle, but in the context of root cause analysis, it makes sense to choose a form that can deal with nonlinearities and correlations between the variables. Alternatively, in the next step, you can also use a machine learning system that can handle incomplete data (Samuele Mazzanti, “Your Dataset Has Missing Values? Do Nothing!”.

Thereafter, there follows a training of a second machine learning system on the (pre-processed) data set. Training can be done by minimizing a MAE or RMSE for a regression and by maximizing an accuracy or kappa for classification. After the training is completed, a determination of the dependencies of the variables from the predetermined variable based on the second trained machine learning system follows.

Preferably, the importance is determined by aggregating the permutation importance and impurity importance. The importance metric is particularly preferred as a lower estimate of the permutation importance (PI) and the impurity importance (II) plus a correction factor. The Permutation Importance (PI) and Impurity Importance (II) values can be aggregated into an Importance Metric according to the following formula to enable simple sorting and selection:

Importance metric=Min(PI,II)+0.75*Range(PI,II).

The advantage of this proposed importance metric is that variables that only receive a high importance according to any metric appear quite high in the ranking and are thus prominently visible to the user. This can be used, for example, to prevent categorical variables with few categories that tend to have a lower II value from slipping too far in the importance metric. At the same time, you don't have to rely solely on the less stable PI, which tends to fluctuate more due to the fact that it is partly determined by extrapolation. This provides a robust and variable-type-independent metric that enables a better system condition.

Preferably, the effect size metric is determined using a range operator applied to the accumulated local effects or ALE value to enable easy sorting and selection:

Effect size metric=Range(ALE)

This proposed effect size metric has the advantage that no assumptions need to be made regarding the type of effect (as would be the case, for example, with the slope of a linear regression), and at the same time, when calculating the influence of changed variable values, only small changes are made to these values to avoid extrapolation and suppress the contributions of other variables. Provided that there are no highly correlated variables, the ALE values can be used to obtain an estimate of the change in the dependent variable as a function of one independent variable at a time. With the calculation of the rank of these ALE values, an estimate of the maximum change in the dependent variable over the entire range of the independent variable is obtained and the Range(ALE) values of all independent variables are comparable with each other because they are alone in units of the dependent variable and the unit of the respective independent variable is irrelevant (the effect size metric). For a calculation of the ALE values, please refer to the publication: Apley, D. W. & Zhu, J. 2020, “Visualizing the effects of predictor variables in black box supervised learning models”, Journal of the Royal Statistical Society. Series B, Statistical methodology, vol. 82, no. 4, pp. 1059-1086.

The variables whose importance and/or effect size are smaller than those of the random variables are advantageously discarded. The remaining variables can be output in descending order according to their importance and/or effect metric or displayed in a 2D scatter plot with these two metrics, wherein a user can identify from the order one or a plurality of variables whose importance in the model or whose effect on the target variable appears to be strongest.

A root cause analysis can then be carried out for these variables. To do this, both the values of the dependent variable and the progress of the ALE values over the range of values of a variable can be displayed and analyzed. Furthermore, 2nd order ALE values can be evaluated for the interaction of the selected variable with other variables (for performance reasons, 2nd order ALE values or analogous effect size values are not calculated for all possible interactions by default; this can be done as required for individual or for all variables).

It is proposed that the data points of the random variable be filtered or deleted from the data set according to a predetermined parsimony factor for each product. The advantage of this is that it allows the parsimony of the original data set to be retained. Thus, the random variable hardly changes any of the characteristics of the data set.

It is noted that the training is preferably performed by the following steps: partitioning the data set into a training, testing and validation data set. It is also conceivable that the data set is additionally divided into a predictive data set comprising non-existing data points for the predetermined variable. This is followed by creating the machine learning system, wherein the machine learning system is trained with selected hyperparameters on the training data, wherein the machine learning system hyperparameters are evaluated on the validation data set, and the trained machine learning system is evaluated on the test data set.

It is proposed that the second machine learning system is a random forest. The random forest is an ensemble of decision trees that are constructed in slightly different ways, wherein each tree being is provided with a different subset of variables during training. That is, each tree receives a different subset of the training data and leaves a subset that is not used (“out of bag samples”). The random forest preferably contains 1500-3000 trees. Particularly preferably, a hyperparameter setting of the trees on the “out of bag samples” is performed, thereby requiring less validation data.

A majority vote of all trees forms the final model, and the predictor variables that contribute the most to purity gain across all trees are ranked according to their impurity importance. A permutation importance can be used to supplement the impurity importance.

Advantages of the random forest as a data-based modeling technique are that complex, non-linear correlations, in particular also between categorical variables, can be found without prior assumptions from experts. Another advantage is that experiments have shown that the random forest has a low overfitting and thus a reliable and robust behavior. Particularly advantageous is that the random forest can handle non-normalized data, missing data, as well as continuous and categorical data. Thus, the disclosure is particularly useful for semiconductor production, in which measurement data are usually sparse. Thus, in combination with the above-described methods for pre-processing the data set, a dependency analysis is provided that can be reliably used for a wide range of different applications.

Furthermore it is proposed that when pre-processing the data set after the first step, a pairwise correlation is additionally determined between a plurality of variables, wherein only one variable of the respective pair is selected for the pairs having a correlation that is, for example, greater than a predetermined threshold value, and the second variable is removed from the data set. It has become clear that the robustness of the method can be significantly increased by deletion of strongly correlated pairs. It is advantageous to also remove the variables from the data set whose correlation is less than or equal to a correlation between the random variable and other variables. This makes it possible to determine the dependencies even more reliably.

It is further proposed that the correlation is determined based on a normalized mutual information. The normalized mutual information is given by: 2*I(X; Y)/(H(X)+H(Y)), wherein I the mutual information is according to Shannon and H an entropy.

It is further proposed that, in the case of a classification, class balancing, such as an upsampling of one of the underrepresented classes or categories, is carried out during training. The class balancing has the advantage that the variables are distributed more evenly in the training data so that a balanced training data set is available, whereby sensible models for classifications with unbalanced classes (e.g. 95% good parts, 5% bad parts) can be achieved.

Furthermore, it is proposed that variables that characterize different components of a common product are aggregated. For example, multiple chips can be aggregated to one frame and/or multiple frames to one wafer. For the data points of the aggregated products, an aggregation method such as mean, median, P10 or P90, etc. can be used. This procedure has the advantage that data sets that are too large for RAM memory can be compressed accordingly. It is also conceivable that aggregation is performed via multiple variables across multiple products.

Furthermore, it is proposed that the data points have been recorded in a semiconductor factory, in particular the data points of the variables in-line measurements and/or PCM measurements and/or wafer level tests and/or characterize a wafer processing history. For example, the wafer processing history describes with which tool the wafer was processed and/or which formulation was used. In particular, the wafer history variables can be categorical variables, e.g., chamber A or B of tool, or similar tools for the individual production steps.

In a further aspect of the disclosure, the trained second machine learning system according to the first aspect of the disclosure can be used to predict the variables for future production steps, in particular to predict any measurements that can have been obtained, and to then decide if necessary whether to further process the product.

In further aspects, the disclosure relates to an apparatus and to a computer program, which are each configured so as to carry out the aforementioned methods, and to a machine-readable storage medium on which said computer program is stored.

### BRIEF DESCRIPTION OF THE DRAWINGS

Embodiments of the disclosure are explained in greater detail below with reference to the accompanying drawings. In the drawings:

FIG. 1 schematically illustrates a flowchart of an embodiment of the disclosure;

FIG. 2 schematically illustrates an embodiment example for controlling a manufacturing system; and

FIG. 3 schematically shows a training device.

### DETAILED DESCRIPTION

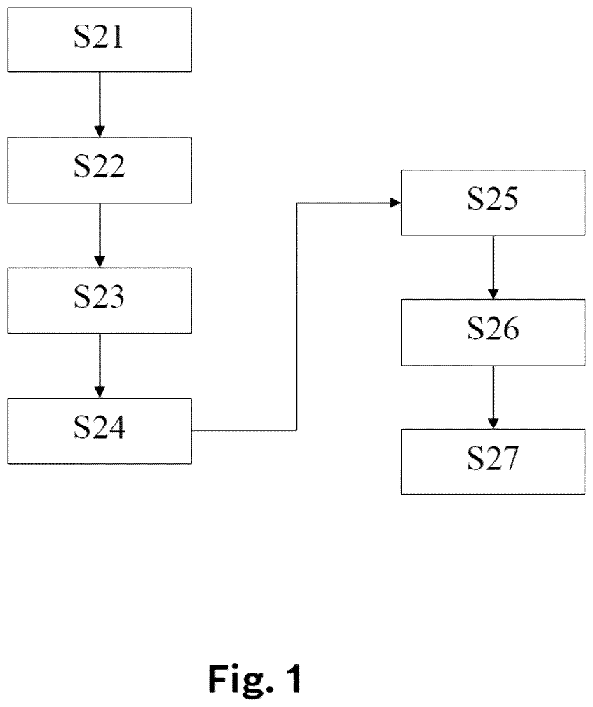

FIG. 1 schematically shows a method for identifying or finding at least one variable from a plurality of variables having a dependence on a predetermined variable from the plurality of variables. For example, spikes are observed in a first measurement V_{T}, which cannot simply be explained with the usual suspicious measurements, such as e.g. THK_{GD} variations. Using the method according to FIG. 1, variables, in particular their associated measurements, can be found that have an influence on the first measurement in order to find a cause for the anomaly of the first measurement.

The method begins with providing (S21) a data set comprising data points for a plurality of the variables for a respective plurality of products, such as semiconductor components. In this embodiment example, the data set is available as a matrix or a table. Then, the variable is selected from the plurality of variables that show atypical behavior or deviation, as exemplified above: the measurement. V_{T}

In general, the following variables are conceivable for semiconductor production: Inline tests (layer thicknesses, depths/widths of structures, etc.), PCM test data (recorded test measurements of individual component tests), wafer level test (EWS), wafer histories (e.g. which production machine has processed which wafer) and/or categorical variables. The categorical variables can be, for example Chamber A or B of a tool, or similar tool variables such as recipe.

Preferably, the data set is available as a table or can be formatted into a table in which the columns are the measurements/variables and the rows are the wafers, frames or chips (both the aggregation level wafer, frame, chip can be configured, as can the aggregation method such as mean, median, P10, etc.). This means that a variable is assigned to each column and a wafer, frame (=litho shot) or chip is assigned to each row.

This is followed by optional pre-processing (S22) of the data set. The pre-processing step (S22) first comprises artificially expanding the data set with random variables and then pre-processing or imputing the artificially expanded data set.

The step of artificially extending the data set comprises several intermediate steps. In the first intermediate step of the artificial extension, two random variables are added to the data set, wherein a numerical random variable and a categorical random variable, which preferably has only two categories, are used. The numerical random variable can describe a normal distribution with a mean of 0 and a standard deviation of 1. The categorical random variable can describe an equal distribution of two categories. Other distributions are possible.

In the second intermediate step of step (S22), a filter grid search is carried out, which applies a larger number of possible filter settings (different threshold values for the allowed sparsity in rows and columns respectively, and different order in the application of filters to rows and columns respectively) to the data set. The filter settings are each designed to produce the effect of filtering the typically high-dimensional data sets with high parsimony. Depending on the (predetermined) parsimony to be achieved and/or depending on the number of usable samples and variables and/or depending on the (predetermined) sample/variable ratio to be achieved, the user can select suitable filter settings from the different resulting data sets.

This means that after the filter grid search step, a plurality of smaller data sets are available. These were created from the original (typically incomplete) data set by applying different threshold values to remove variables (columns) or observations (rows), resulting in several possible smaller data sets that contain fewer columns and/or rows and fewer gaps. The user will now preferably select one of these data sets based on the information about remaining rows, columns and resulting gaps.

After the artificial expansion of the data set has been completed, a first step of pre-processing the data set follows, in which a row- and/or column-wise deletion of those variables and/or products occurs that show a sparsity of the data points greater than a predeterminable threshold value.

Additionally or alternatively, correlated variables can be removed in a separate step. To do this, a correlation value can be calculated between all remaining columns in pairs with all pairwise complete rows (“pairwise complete”). The user can use a correlation matrix (in which the correlation values of the two random variables also appear with all others as a reference) to set a threshold for the correlation value above which one of two correlated variables is removed (the one that has the higher correlation with all other variables on average is removed, since this carries less additional information). Alternatively, the user can manually remove one of two correlated variables based on their expertise.

In the second step of pre-processing, missing data points of the variables are imputed. For performance reasons, imputation is carried out in several stages, i.e. the quality of the imputed values is iteratively improved. In the first stage of imputation, missing data points are replaced with the data point of the respective variable that occurs most frequently (categorical variables) or occurs on average across the plurality of the products (numerical variables). In the second stage of imputation, a first machine learning system is trained so that it can predict the imputed values from the first stage with greater accuracy. After that, the replaced data points are replaced with new data points from the first machine learning system. This procedure is repeated until an abort criterion is reached (e.g. number of iterations or relative change from imputed value n to imputed value n+1). Preferably, a model that can deal with nonlinearities and correlations between variables (e.g., a random forest) is trained only on the training part of the data set and then used to impute values in both the training and test data sets. Alternatively, multiple data sets can also be imputed independently of each other and multiple models can then be trained in the next step.

After the data set has been processed according to the pre-processing step (S22), a second machine learning system is trained (S23) on the pre-processed data set. For the training, the data set can be split into train/test data as usual, i.e. a train data set on which the second machine learning system learns to predict the target variable and a test data set to test the trained second machine learning system. It should be noted that the splitting of the data set can alternatively be carried out before the imputation step and only then the imputation.

In a preferred embodiment of training S23, hyperparameter tuning and model training are carried out. Preferably, the second machine learning system is a random forest. The random forest is an ensemble of a large number of decision trees, all of which can be trained with a different subset of variables and samples (in the case of classification, class balancing is performed after selecting the samples), and a majority vote on all trees forms the final model.

For the random forest, two hyperparameters can be optimized: the number of variables used in a decision tree and the minimum number of observations in a final node. The search space for the former is automatically adjusted based on the total number of variables and the tuning is done automatically based on the out-of-bag error (kappa for classification and RMSE for regression). The latter can be adjusted manually by the user based on the results of an initial model, wherein automated hyperparameter tuning would also be conceivable here. For this purpose, typical performance metrics of the model for train and test are provided to the user.

After the training step (S23), there is the option of verifying (S24) the trained model on the test data set.

In the event that the target variable is not available in the extended data set, but all other variables or a plurality of the other variables are available, a prediction of the target variable and an addition of this to the extended data set can be carried out.

This allows the user, in particular, to check (S25) the trained second machine learning system. The aim of the check may be to start a further training run S23 with adjusted settings (e.g. a reduced selection of variables or other threshold values, etc.).

The test can be carried out on the basis of one or more of the criteria listed below:
1. The test can be carried out with regard to model quality. This can be used to assess overfitting and, if necessary, to adjust the hyperparameter minimum number of samples for leaf nodes of the decision trees.
2. The test can be carried out with regard to a relative prediction error with regard to the target variable. In this case, the prediction error is plotted against the target variable in order to be able to assess whether the error changes systematically with the value of the target variable. If this is the case, it may indicate that important variables were not part of the model and this can be taken into account when adjusting the variable selection.
3. The test can be carried out with regard to a variable importance or effect size ranking. First, the variables that were excluded due to sparseness or correlation can be reviewed by the subject matter expert. Next, the variables that are part of the model are examined. The importance or effect size metrics of the two random variables serve as a reference and those variables with lower metric values than the random variables can be removed from the data set after a professional review if necessary.
4. A correlation matrix based on mutual information can also be used to check the variables excluded due to correlation. This helps to understand which variables correlate strongly and, in addition to checking general correlation patterns, allows you to understand which second variable a first variable was removed due to because of too high correlation. If, from an expert's point of view, the “wrong” variable has been removed from two correlated variables, the user can correct this decision of the model. In addition, the correlation values of the random variables with “real” variables can be used to adjust the threshold value for removing correlated variables for a further run if necessary.

After step S25 has been completed, step S26 follows. The top N variables are identified. The proposed importance metric, which is an aggregation of the permutation importance and the impurity importance, is used to identify the top N variables. The user can select N freely or can automatically set all N variables above the importance of the random variables using the random variables. In addition, the user can adjust model parameters that control over-/underfitting.

The next step, after step S27 has been completed, is step S27. In this step, the importance and effects metrics are determined for the specific top N variables from step S26. For the top N variables and the two random variables, an importance and an effects metric are calculated on the test data set. Since this is only done for a subset of the variables, more expensive methods can be used than for determining the top N, and the results can also be used to calculate an error estimate. The user can view the metrics, raw data and effect in the model only for the top N variables and check them for plausibility using expert knowledge, or derive suitable measures or experiments.

In a preferred embodiment of the method of FIG. 1, the categorization quality of the second machine learning system is evaluated after step S23 for fine tuning. For example, the variables with a low determined importance or effect value can be removed from the training data set according to step S27 and the sequence of steps S23 to S27 can be repeated. It is also conceivable for the evaluation of the second machine learning system that prediction errors of the machine learning system are considered and that the second machine learning system is retrained depending on the type of error.

Variables with a low importance or effect value can be removed using a predefined threshold value. The threshold value can be predetermined.

Particularly preferably, a result of the method according to FIG. 1 is interactively visualized for evaluation so that an expert can selectively perform the evaluation via the visualization. This also has the advantage that expert knowledge is implicitly incorporated by the interactive visualization.

The dependences resulting from step S25 can then be used to optimize production steps and enable faster and more informed Design of Experiment (DoE) tuning of machines during the start-up phase of new production lines.

If, for example, a measurement is V_{T} outside a specified or tolerable range, the variable importance ranking and/or effect size ranking from step S25 can be used to determine which variables from the data set correlate most strongly with the associated variable of the measurement V_{T} or can influence it most strongly. From these correlating variables it can then be deduced to what extent a production process, which has an influence on the correlating variables, needs to be adjusted. Thus, it is possible to track which production step resulted in the incorrect measurements. That is, the method according to FIG. 1 can be used for root cause analysis. The adaptation can be done, for example, by adapting process parameters, preferably by adapting these process parameters in a control system accordingly.

It is also conceivable that the adjustment of the process parameters is dependent on an absolute deviation of the predetermined measurement to the specified or tolerable value range and can be done depending on an importance value of the Variable Importance Rankings from step S25 and optionally based on a physical domain model that can characterize dependences between the production steps and variables to be correlated. It should be noted that depending on the method just mentioned, variables can be identified that are redundant (because they are highly correlated) and thus their associated tests can be removed. This results in a reduction of a list of necessary tests and thus an advantageous reduction of the measurement time.

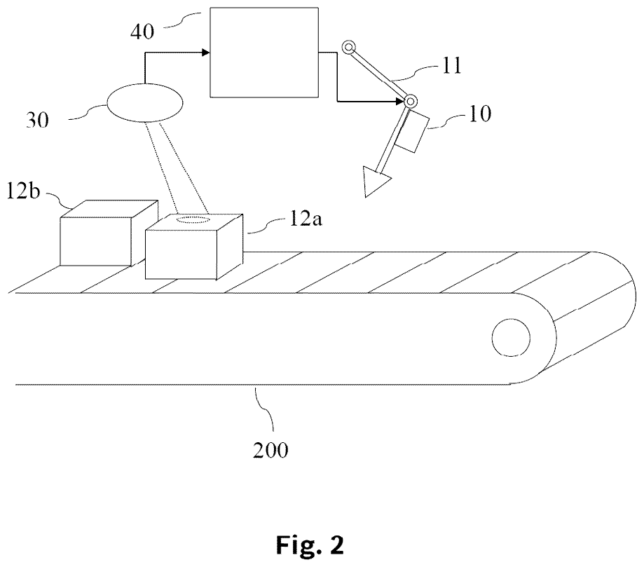

FIG. 2 shows an embodiment example in which the control system 40 with the adapted process parameters is used to control a fabrication machine 11 of a fabrication system 200, in that this fabrication machine 11 controls the actuator 10. The fabrication machine 11 can be, for example, a machine for punching, sawing, drilling, milling, and/or cutting, or a machine that performs a step of a semiconductor production process, such as chemical deposition methods, etching and cleaning processes, physical deposition and cleaning methods, ion implantation, crystallization or temperature processes (diffusion, annealing, melting, etc.), photolithography, or chemical mechanical planarization.

For example, sensor 30 can be a measurement sensor or detector that captures characteristics of manufacturing products 12a, 12b, wherein the data points hereby recorded preferably are provided with the method of FIG. 1.

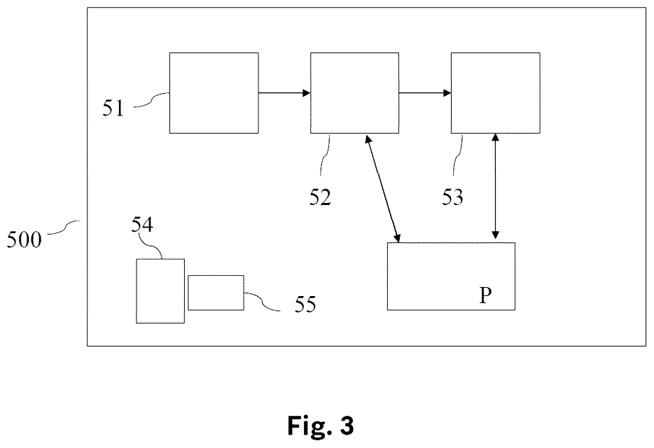

FIG. 3 schematically shows a training device 500 comprising a provisioner 51 that provides instances from a training data set. The instances are supplied to the training machine learning system 52 to be trained, which uses them as output variables to determine, for example, a classification or regression. Output variables and instances are supplied to an evaluator 53, which determines updated hyper-/parameters therefrom, which are transmitted to the parameter memory P and replace the current parameters there. The evaluator 53 is configured to perform steps S23 of the method shown in FIG. 1.

The methods carried out by the training device 500 can be stored as a computer program implemented on a machine-readable storage medium 54 and executed by a processor 55.

The term “computer” comprises any device for processing specifiable calculation rules. These calculation rules can be provided in the form of software or in the form of hardware or also in a mixed form of software and hardware.

What is claimed is:

1. A computer-implemented method for identifying at least one variable from a plurality of variables having a dependence on a predetermined variable from the plurality of variables, wherein the variables respectively characterize measurements after production steps of a product or production steps or machine settings of machines performing one of the production steps, the method comprising:
providing a data set comprising data points for a plurality of variables for a plurality of products respectively and providing the predetermined variable from the plurality of variables;
pre-processing the data set comprising extending the data set by at least one random variable characterizing a probability distribution, wherein data points for the random variable are randomly drawn according to the probability distribution and added to the data set;
training a second machine learning system on the pre-processed data set; and
determining dependencies of the variables on a given variable based on the second trained machine learning system, wherein variables that have a dependency less than or equal to a dependency of the random variables are rejected,
wherein the dependencies are determined using an importance metric and/or an effect metric,
wherein an importance metric is determined based on an aggregation of a permutation importance and an impurity importance, and
wherein the effect metric is determined using an accumulated local effects value.

2. The method according to claim 1, wherein:
the importance metric is determined using a formula of a summation of: Min(PI, II)+0.75Range(PI, II), and
the permutation importance is given by PI and the impurity importance by II.

3. The method according to claim 1, wherein the effect metric is determined based on a range operator applied to the accumulated local effects value.

4. The method according to claim 1, wherein the predetermined variable has an abnormal behavior including values outside of a specified range of values.

5. The method according to claim 1, wherein the data points of the variables are in-line measurements, PCM measurements, wafer level tests, and/or a wafer processing history.

6. The method according to claim 1, wherein a production process for producing the products is adjusted based on the determined dependencies of the variables and depending on a range of values of the predeterminable variable to be achieved.

7. An apparatus configured to carry out the method according to claim 1.

8. The method according to claim 1, wherein a computer program comprises commands which, when the computer program is performed by a computer, cause the computer to carry out the method.

9. A non-transitory machine-readable storage medium on which the computer program, according to claim 8, is stored.
